(19) United States
(12) Patent Application Publication
(10) Pub. No.: US 2016/0243513 A1
(43) Pub. Date: Aug. 25, 2016

(54) SYSTEM INCLUDING AN ELECTRICALLY-DRIVEN MIXING DEVICE FOR MIXING A COATING

(71) Applicant: TURBO SPRAY MIDWEST, INC., Howell, MI (US)

(72) Inventor: James E. Hynds, West Bloomfield, MI (US)

(21) Appl. No.: 14/627,125

(22) Filed: Feb. 20, 2015

(51) Int. Cl. B01F 15/00; B01F 1/00; B01F 7/16

(52) U.S. Cl. CPC B01F 15/00538; B01F 7/16; B01F 15/00441; B01F 15/00201; B01F 1/0011; B01F 15/00448; B01F 2215/005; B01F 2015/00623

(57) ABSTRACT

A system including an electrically-driven mixing device for mixing a water or solvent-based coating is provided. The mixing device includes a supply container, a rotary agitator shaft and an agitator disposed within the container and coupled to the agitator shaft to rotate therewith. The agitator mixes a coating contained within the container upon rotation of the agitator shaft. The solvent-based coating creates a flammable vapor environment around the container wherein a source of ignition is capable of igniting flammable vapors in the environment. A drive mechanism includes an electric motor having a rotary output shaft disposed outside of the environment and a mechanical power transmission coupled to the output shaft of the motor and to the agitator shaft of the device to transfer torque from the output shaft to the agitator shaft to mix any coating in the container.

### TECHNICAL FIELD

This invention relates to systems including driven mixing devices for mixing water or solvent-based coatings and, in particular, to systems including electrically-driven mixing devices for mixing such coatings.

### Overview

The term “coating” refers to various mixes of solid components and liquid components to form a liquid mixture, either true solution where solids fully dissolve or dispersion where solids are simply mixed in liquid. Approximately 50% of these coatings are waterbase and 50% are solvent-based in the industry. These coatings are used in painting, adhesive, low friction and many more fields depending on the characteristics of their films. These coatings can be applied to a surface using several means including, dipping, atomized spray applicators, flow coated (no atomizing air) or brushed. In all cases these coatings can settle (separate) where coating solids drop to the bottom of a container and the liquid portion of the mixture remains on top. This is referred to as coating striation.

Coating striation results in an altered coating formulation which when applied to a surface and subsequently dried, results in an incomplete film, i.e., too much liquid or too much solids in the final applied film. Incomplete dry films result in a number of unfavorable results. Specifically:
Too much liquid
   Low dried film solids result in lower film thickness
   Incomplete dry characteristics
Result
   Poor physical performance (chemical resistance—poor weathering—poor salt spray—poor color control—poor adhesion
Too many solids in the final film exhibits the same undesirable physicals (film characteristics)

Thorough mixing of the coatings prior to and during application is necessary for desirable dry film characteristics.

Traditionally air agitator motors have been used, driven by compressor supplied pressurized air. It is convenient to use air motors since most plants have compressors and agitator air motors present no problem in flammable vapor environments created by solvent-based coatings. Air mixing motors are typically the single largest user of compressed air in any finishing operation.

The problem with air agitators are several:
‘Stall’—motor stops without warning especially at low RPM's
Inaccurate speeds and no good way of confirming actual agitation in the vessel
Compressor air is expensive and often contaminated with water and oil
Air motors must be lubricated regularly with the possibility of coating contamination
An air motor with or without an accompanied gearbox tends to stall at low speeds. Most water-based dispersions require very low RPM (say 1 RPM/second) or they will foam or aerate. This causes aerated dry films and resultant performance issues. By the same token they must be agitated at a sufficient RPM or will settle rapidly. Exact RPM control is necessary. This applies to most coatings.

When solvent-based coatings are used in a mixing vessel, the area around the mixing vessel is “classified”. The reason is that any sort of spark (source of ignition) can ignite the vapors around the coating vessel. All plants that use flammable coatings must adhere to safety rules which apply to these areas. It is necessary to comply to OSHA, safety and insurance rules. The classification rules are well defined by NEC (National Electronic Code) NFPA (National Fire Prevention Act) and other agencies such as FM Global.

Specifically the area around a mixing vessel which contains a solvent-based coating is classified as a Class I Div. I and Class I Div. II by NFPA 70. These areas are defined by arcs or radii around the mixing vessel. Class I Div. I is defined as an area where flammable vapors will be present (especially when the vessel lid is removed for refill). This area is defined in the first 3 ft. arc in all directions around the mixing vessel. No source of ignition is allowed in this area. If electric drive motors are used in this area they must be the more expensive, heavier, explosion-proof type when mounted on the vessel lid. These type of motors cause ergonomic issues for operators since they are very heavy. Also, an explosion-proof power cable must be run from the electric control panel to the electric motor.

Class I Div. II creates a second arc or radius 5 ft. away from the vessel in all directions where flammable vapors might be present. In this area “sealed” electric motors are allowed but not necessarily explosion-proof. Outside of the 5 ft. arc or radius any “normal” electric device is allowed.

All space in all directions within 2 ft. of a Division I area surrounding supply containers as well as the area extending 5 ft. beyond the Division 1 area up to a height of 1½ ft. above the floor or grade level is defined as a Class 1 Div. 2 area.

The following U.S. Pat. No. references are generally related to at least one aspect of the present invention: 4,401,268; 4,984,745; 5,421,218; 5,949,209; 6,835,248; 7,915,773; 8,667,926; and 2011/0315785.

### SUMMARY OF EXAMPLE EMBODIMENTS

An object of at least one embodiment of the present invention is to provide a system including an electrically-driven mixing device for mixing a water or solvent-based coating without the need for an explosion-proof electric motor.

In carrying out the above object and other objects of at least one embodiment of the present invention, a system including an electrically-driven mixing device for mixing a water or solvent-based coating is provided. The mixing device includes a supply container, a rotary agitator shaft and an agitator disposed within the container and coupled to the agitator shaft to rotate therewith. The agitator mixes a water or solvent-based coating contained within the container upon rotation of the agitator shaft. The solvent-based coating creates a flammable vapor environment around the container wherein a source of ignition is capable of igniting flammable vapors in the environment. A drive mechanism includes an electric motor having a rotary output shaft disposed outside of the environment and a mechanical power transmission coupled to the output shaft of the motor and to the agitator shaft of the device to transfer torque from the output shaft to the agitator shaft to mix any coating in the container.

The system may further include a controller for supplying electrical power to the motor and for controlling the motor. The controller is disposed outside of the environment and is electrically connected to the drive mechanism to operate the motor through an electrical power cable.

The controller may be programmable wherein the controller controls the motor in accordance with a predetermined mixing program.

The electric motor may be a non-explosion proof electric motor.

The electrical power cable may be a non-explosion proof electrical power cable.

The mechanical power transmission may include an elongated transmission shaft having opposite ends. The first end may be located within the environment and may be coupled to the agitator shaft. A second end may be located outside the environment and may be coupled to the output shaft of the motor.

The transmission shaft may be flexible or rigid.

The power transmission may include a gear mechanism coupled to the transmission shaft and the agitator shaft. The rotary speed of the agitator shaft may be less than the rotary speed of the motor.

The supply container may include a lid wherein the agitator shaft extends through the lid.

The lid may be removable.

The system may further include a housing for housing the controller and to mount the controller and the motor on an exterior surface of a spray booth outside of the environment.

The controller may monitor electrical power supplied to the motor to determine an operating state of the mixing device.

The coating may be a water or solvent-based paint.

Further in carrying out the above object and other objects of at least an embodiment of the present invention, a system including an electrically-driven mixing device for mixing a water or solvent-based coating is provided. The mixing device includes a supply container, a rotary agitator shaft and an agitator disposed within the container and coupled to the agitator shaft to rotate therewith. The agitator mixes a water or solvent-based coating contained within the container upon rotation of the agitator shaft. The solvent-based coating creates a flammable vapor environment around the container wherein a source of ignition is capable of igniting flammable vapors in the environment. A drive mechanism includes an electric motor having a rotary output shaft disposed outside of the environment and a mechanical power transmission coupled to the output shaft of the motor and to the agitator shaft of the device to transfer torque from the output shaft to the agitator shaft to mix any coating in the container. The system also includes an electrical power cable and a controller for supplying electrical power to the motor and for controlling the motor. The controller is disposed outside of the environment and is electrically connected to the drive mechanism to operate the motor through the electrical power cable.

The controller may be programmable wherein the controller controls the motor in accordance with a predetermined mixing program.

The electric motor may be a non-explosion proof electric motor.

The electrical power cable may be a non-explosion proof electrical power cable.

Still further in carrying out the above object and other objects of at least one embodiment of the present invention, a system including an electrically-driven mixing device for mixing a water or solvent-based coating is provided. The mixing device includes a supply container, a rotary agitator shaft and an agitator disposed within the container and coupled to the agitator shaft to rotate therewith. The agitator mixes a water or solvent-based coating contained within the container upon rotation of the agitator shaft. The solvent-based coating creates a flammable vapor environment around the container wherein a source of ignition is capable of igniting flammable vapors in the environment. A drive mechanism includes an electric motor having a rotary output shaft disposed outside of the environment and a mechanical power transmission coupled to the output shaft of the motor and to the agitator shaft of the device to transfer torque from the output shaft to the agitator shaft to mix any coating in the container. The mechanical power transmission includes an elongated transmission shaft having opposite ends. A first end is located within the environment and is coupled to the agitator shaft and a second end is located outside the environment and is coupled to the output shaft of the motor.

The transmission shaft may be flexible.

The power transmission may include a gear mechanism coupled to the transmission shaft and the agitator shaft. The rotary speed of the agitator shaft may be less than the rotary speed of the motor.

Other technical advantages will be readily apparent to one skilled in the art from the following figures, descriptions and claims. Moreover, while specific advantages have been enumerated, various embodiments may include all, some or none of the enumerated advantages.

### BRIEF DESCRIPTION OF THE DRAWINGS

For a more complete understanding of the present invention, and for further features and advantages thereof, reference is made to the following description taken in conjunction with the accompanying drawings, in which:

FIG. 1 is a schematic, perspective environmental view of a coating spray booth and an operator who is using a system constructed in accordance with at least one embodiment of the present invention;

FIG. 2 is a front schematic view of a control panel with a housing which houses a motor controller and which mounts an electric motor on the spray booth of FIG. 1; a flexible transmission shaft, partially broken away, extends from a drive shaft of the motor; and

FIG. 3 is a front schematic view of a mixing device including a supply container and an agitator shaft and agitator indicated by phantom lines within the container; the flexible transmission shaft of FIG. 2 is partially broken away and extends from a gear box.

### DETAILED DESCRIPTION OF EXAMPLE EMBODIMENTS

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In general, and as described below, at least one embodiment of the present invention provides a system, generally indicated at 10, including an electrically-driven mixing device, generally indicated at 12, for mixing a water or solvent-based coating contained therein.

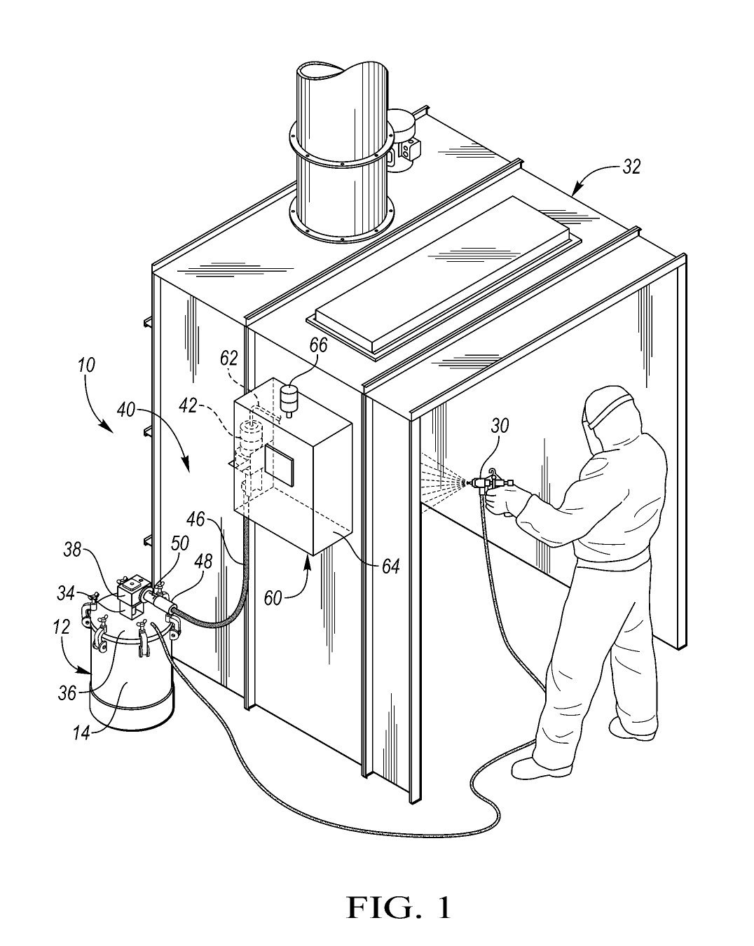

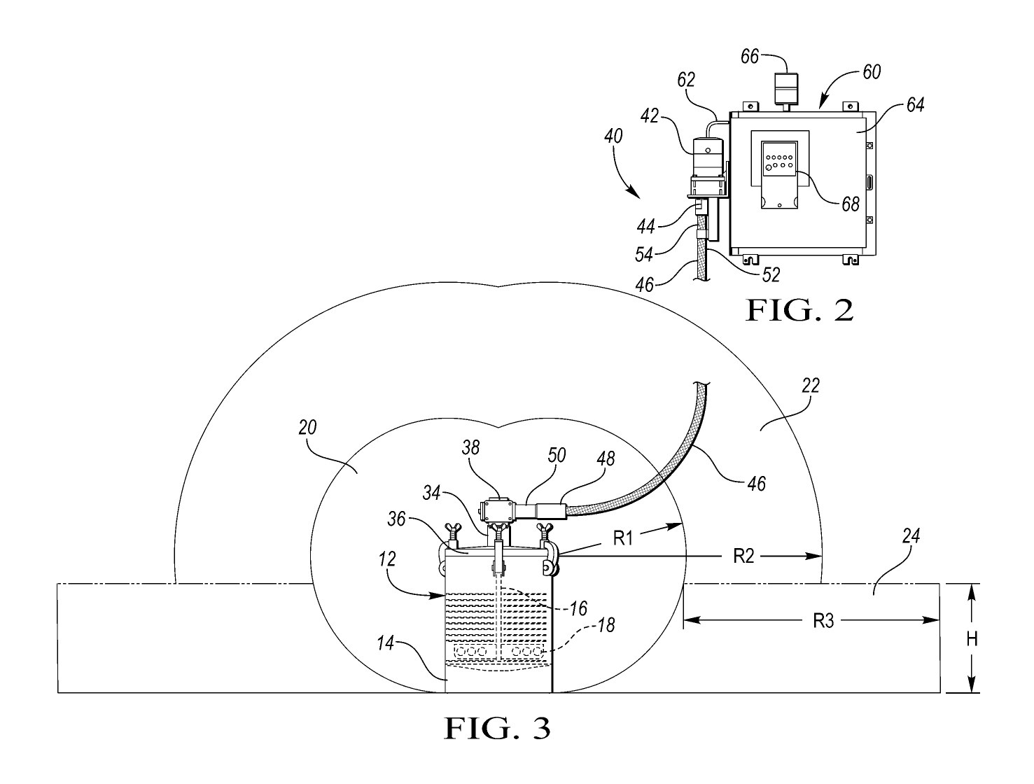

As shown in FIGS. 1 and 3, the mixing device 12 includes a supply container 14, a rotary agitator shaft 16 and an agitator 18 disposed within the container 14 and coupled to the agitator shaft 16 to rotate therewith. The agitator 18 mixes a water or solvent-based coating contained within the container 14 upon rotation of the agitator shaft 16. The solvent-based coating creates a flammable vapor environment around the container 14 wherein a source of ignition is capable of igniting flammable vapors in the environment. FIG. 3 shows various areas around the container 14 as defined by NFSA 70. A first area 20 is a class A Div. 1 area which extends a first radius, (R1, 3 ft.) around the container 14. A second area 22 is a class 1 Div. 2 area which extends a second radius, (R2, 5 ft.) around the container 14. A third area 24 is also a class 1, Div. 2 area which extends a radius, R3, (i.e. 5 ft. beyond the Div. 1 area) around the container 14 and extends a height, H, (i.e. 1½ ft.) above the floor or grade level on which the container 14 sits.

Referring again to FIG. 1, an operator is shown operating a spray gun 30 which sprays the coating in a coating spray booth, generally indicated at 32. The coating may be a water or solvent-based paint.

Referring again to FIG. 3, the agitator shaft 16 extends through a bearing pac 34 supported on a removable lid 36 of the container 14. The shaft 16 extends through the lid 36 and is coupled to a gear mechanism or box 38 of a drive mechanism, generally indicated at 40. The gear box 38 typically reduces the rotary speed of the shaft 16 below the rotary speed of a shaft 44 of an electric, non-explosion-proof motor 42 disposed outside of the environment.

The drive mechanism 40 includes the motor 42 and a mechanical power transmission coupled to the output shaft 44 of the motor 42 and to the agitator shaft 16 of the device 12 to transfer torque from the motor shaft 42 to the agitator shaft 16 to mix any solvent-based coating in the container 14. The mechanical power transmission comprises an elongated transmission shaft or cable 46 having opposite ends. A first end 48 is located within the environment and is coupled to the agitator shaft 16 via the gearbox 38 and a quick release coupling 50. A second end 52 of the shaft 46 is located outside the environment and is coupled to the output shaft 44 of the motor 42 via a coupling 54.

Preferably, the shaft 46 is flexible but could alternatively be a rigid drive shaft. A rigid drive shaft would typically require locating the agitator shaft 16 of the mixing vessel 12 directly in line with the electric motor shaft 44. This might provide difficult in practice since agitator vessels are moved frequently.

A flexible shaft cable such as the shaft 46 typically comprises a flexible shaft assembly which transmits rotary motion much like a solid steel shaft, but it can be routed over, under, and around obstacles that would make using a solid shaft impractical. Such a flexible shaft assembly typically includes a rotating shaft (sometimes called a core) with end fittings for attachment to the driving and driven mating parts. A protective outer casing is used when necessary. This casing has its own fittings, called ferrules, which keep it stationary during use.

A flexible shaft or cable is an effective means or mechanism of transmitting rotary motion and is more often efficient than universal joints, gears, sprockets and chains, or belts and pulleys. It offers the added benefit of compensating for misalignments in the system 10 that can greatly reduce cost and assembly time.

The system 10 further includes a variable frequency drive or controller generally indicated at 60, for supplying electrical power to the motor 42 and for controlling the motor 42. The controller 60 is disposed outside the environment and is electrically connected to the motor 42 through an electrical power cable 62 which is a non-explosion-proof electrical power cable. A housing 64 houses the controller 60 and a graphical user interface 68 for the controller 60 and mounts the controller 60 and the motor 42 on the outer surface of a wall of the spray booth 32. A transformer 66 for the controller 60 is typically supported on the housing 64.

The controller 60 is typically programmable wherein the controller 60 controls the motor 42 in accordance with a predetermined mixing program.

The electric agitator drive of at least one embodiment of the present invention provides many advantages:
Will not stall out at lower RPM's
Extremely accurate RPM control and verification
Method of confirming agitation that is actually taking place (agitator 18 itself is actually turning in the vessel 14). This is evident by detecting a lower amperage draw in the motor 42 if there is less resistance from the agitator or propeller 18.
Approximately ⅓ the energy cost for electric drives versus air motor drives with associated cost of compressed air.

Confirming agitation
Short of mounting a proximity switch on the vessel lid 36 pointing at the head of the agitator 18, there has been no way to confirm that agitation is actually taking place. For example, a propeller 18 could fall off of the agitator shaft 16 or the agitator shaft 16 detaches from the drive motor 42 (i.e., the device 12 changes its operating state). A power wire and a proximity switch is cumbersome and often broken when the lid 36 is removed. Further, a proximity switch had to be explosion-proof if solvent fumes are present. Detection of amperage drop in an electric drive or mechanism 40 can be determined quite easily without a cumbersome cable and a proximity switch.
There is no good way of controlling the RPM of air motors. Further, they are not consistent due to varying coating level resistance and compressor outputs. All of these problems are eliminated with the electric drive 40 of at least one embodiment of the present invention.

Lower energy costs
The KW power draw of an electric agitator motor 42 is ⅓ the KW draw of an air agitator motor. Furthermore, a plant can now shut compressors down for maintenance, weekends, holidays etc. without the worry of coating settling.

The remote electric motor 42 which uses the drive cable 46 which extends to the vessel agitator shaft 16 solves many of these problems. Although the flexible drive cable 46 works best, a rigid drive shaft extending from the drive motor 42 to the vessel agitator shaft 16 would work as well.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system including an electrically-driven mixing device for mixing a water or solvent-based coating, the system comprising:
a mixing device including a supply container, a rotary agitator shaft and an agitator disposed within the container and coupled to the agitator shaft to rotate therewith, the agitator mixing a water or solvent-based coating contained within the container upon rotation of the agitator shaft, the solvent-based coating creating a flammable vapor environment around the container wherein a source of ignition is capable of igniting flammable vapors in the environment; and
a drive mechanism including an electric motor having a rotary output shaft disposed outside of the environment and a mechanical power transmission coupled to the output shaft of the motor and to the agitator shaft of the device to transfer torque from the output shaft to the agitator shaft to mix any coating in the container.

2. The system as claimed in claim 1, further comprising a controller for supplying electrical power to the motor and for controlling the motor, the controller being disposed outside of the environment and electrically connected to the drive mechanism to operate the motor through an electrical power cable.

3. The system as claimed in claim 2, wherein the controller is programmable and wherein the controller controls the motor in accordance with a predetermined mixing program.

4. The system as claimed in claim 1, wherein the electric motor is a non-explosion proof electric motor.

5. The system as claimed in claim 2, wherein the electrical power cable is a non-explosion proof electrical power cable.

6. The system as claimed in claim 1, wherein the mechanical power transmission includes an elongated transmission shaft having opposite ends, a first end being located within the environment and coupled to the agitator shaft and a second end being located outside the environment and coupled to the output shaft of the motor.

7. The system as claimed in claim 6, wherein the transmission shaft is flexible.

8. The system as claimed in claim 6, wherein the power transmission includes a gear mechanism coupled to the transmission shaft and the agitator shaft, wherein the rotary speed of the agitator shaft is less than the rotary speed of the motor.

9. The system as claimed in claim 1, wherein the supply container includes a lid and wherein the agitator shaft extends through the lid.

10. The system as claimed in claim 9, wherein the lid is removable.

11. The system as claimed in claim 2, further comprising a housing for housing the controller and to mount the controller and the motor on an exterior surface of a spray booth outside of the environment.

12. The system as claimed in claim 2, wherein the controller monitors electrical power supplied to the motor to determine an operating state of the mixing device.

13. The system as claimed in claim 1, wherein the coating is a water or solvent-based paint.

14. A system including an electrically-driven mixing device for mixing a water or solvent-based coating, the system comprising:
a mixing device including a supply container, a rotary agitator shaft and an agitator disposed within the container and coupled to the agitator shaft to rotate therewith, the agitator mixing a water or solvent-based coating contained within the container upon rotation of the agitator shaft, the solvent-based coating creating a flammable vapor environment around the container wherein a source of ignition is capable of igniting flammable vapors in the environment;
a drive mechanism including an electric motor having a rotary output shaft disposed outside of the environment and a mechanical power transmission coupled to the output shaft of the motor and to the agitator shaft of the device to transfer torque from the output shaft to the agitator shaft to mix any coating in the container;
an electrical power cable; and
a controller for supplying electrical power to the motor and for controlling the motor, the controller being disposed outside of the environment and electrically connected to the drive mechanism to operate the motor through the electrical power cable.

15. The system as claimed in claim 14, wherein the controller is programmable and wherein the controller controls the motor in accordance with a predetermined mixing program.

16. The system as claimed in claim 14, wherein the electric motor is a non-explosion proof electric motor.

17. The system as claimed in claim 14, wherein the electrical power cable is a non-explosion proof electrical power cable.

18. A system including an electrically-driven mixing device for mixing a water or solvent-based coating, the system comprising:
a mixing device including a supply container, a rotary agitator shaft and an agitator disposed within the container and coupled to the agitator shaft to rotate therewith, the agitator mixing a water or solvent-based coating contained within the container upon rotation of the agitator shaft, the solvent-based coating creating a flammable vapor environment around the container wherein a source of ignition is capable of igniting flammable vapors in the environment; and
a drive mechanism including an electric motor having a rotary output shaft disposed outside of the environment and a mechanical power transmission coupled to the output shaft of the motor and to the agitator shaft of the device to transfer torque from the output shaft to the agitator shaft to mix any coating in the container wherein the mechanical power transmission includes an elongated transmission shaft having opposite ends, a first end being located within the environment and coupled to the agitator shaft and a second end being located outside the environment and coupled to the output shaft of the motor.

19. The system as claimed in claim 18, wherein the transmission shaft is flexible.

20. The system as claimed in claim 18, wherein the power transmission includes a gear mechanism coupled to the transmission shaft and the agitator shaft, wherein the rotary speed of the agitator shaft is less than the rotary speed of the motor.
